(19) United States
(12) Patent Application Publication
(10) Pub. No.: US 2008/0023402 A1
(43) Pub. Date: Jan. 31, 2008

(54) Water filtration systems and methods

(75) Inventors: James Rulon Young Rawson, Clifton Park, NY (US); William Jordan Heward, Saratoga Springs, NY (US); Shane Alan Gernand, Glenville, NY (US); Samuel Vincent DuPlessis, Louisville, KY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/638,221

(22) Filed: Dec. 13, 2006

Related U.S. Application Data
(60) Provisional application No. 60/834,237, filed on Jul. 28, 2006.

(51) Int. Cl. C02F 1/28

(52) U.S. Cl. 210/663; 210/335; 210/912

(57) ABSTRACT

A filter for removing soluble and insoluble lead from water supplied by a water source includes a first filter medium configured to adsorb soluble lead to facilitate removing soluble lead from the water. A second filter medium is operatively coupled in series with the first filter medium and configured to facilitate physically removing insoluble colloidal lead from the water.

### CROSS REFERENCE TO RELATED APPLICATIONS

This application claims the benefit of U.S. provisional application Ser. No. 60/834,237 filed Jul. 28, 2006, which is hereby incorporated by reference in its entirety.

### BACKGROUND OF THE INVENTION

This invention relates generally to water filtration systems and, more particularly, to water filtration systems configured to remove lead and other contaminants from water supplied by a water source.

In general, insoluble lead particles may be removed by mechanical filtration methods provided the filter has pores small enough to exclude the insoluble lead particles. Separation efficiency is increased with filters containing smaller pore sizes, although higher pressures are needed to maintain flow through the filter. In the case of residential water purification, however, the mechanical filtration of insoluble lead cannot be done at pressures higher than those existing at the building point of entry (POE), typically 60 psi. Moreover, in some point of use (POU) lead filters, such as pitcher filters, there is no pressure driving force through the filter except for gravity, and so high efficiency mechanical filtration methods are not suitable for such application. Alternative practical solutions to the removal of insoluble lead are needed in residential water applications.

As much as about 40% to about 60% of the lead in drinking water may be insoluble and exist as colloidal or particulate matter. This colloidal lead exists as particles in the micron and sub-micron size. Lead is often released into drinking water distribution systems from municipal distribution lead pipes, brass fixtures and/or lead-based solders. The U.S. Environmental Protection Agency (USEPA) has set the action level for lead in drinking water at 15 micrograms/L (μg/L). When drinking water systems are devoid of materials that contain lead, this concentration of lead can be easily achieved. However, when lead is present in a drinking water distribution system, the total concentration of lead in the drinking water can often exceed the USEPA action level for lead. Therefore, consumers may install a POU filter to facilitate removal of a sufficient amount of lead from the drinking water to meet the USEPA action level for this contaminant. However, in the past, it was generally not recognized that a substantial quantity of insoluble colloidal lead had to be removed from drinking water to meet the USEPA action level for lead. Therefore, POE filters and POU filters configured to remove lead must be capable of removing both insoluble colloidal lead and soluble lead from residential drinking water.

### BRIEF DESCRIPTION OF THE INVENTION

In one aspect, a filter for removing soluble and insoluble lead from water supplied by a water source is provided. The filter includes a first filter medium configured to adsorb soluble lead to facilitate removing soluble lead from the water. A second filter medium is operatively coupled in series with the first filter medium and configured to facilitate physically removing insoluble colloidal lead from the water.

In a further aspect, a filter assembly is provided. The filter assembly is coupled to a water distribution system for removing soluble and insoluble lead from water supplied by the water distribution system. The water distribution system includes a filter assembly cap in fluid communication with the water source and defining an inlet and an outlet. The filter assembly includes a filter housing coupled to the filter assembly cap and in fluid communication with the water source. The filter housing is configured to receive unfiltered water through the inlet. A filter is positioned within the filter housing. The filter includes a first filter medium configured to adsorb soluble lead to facilitate removing soluble lead from the water and a second filter medium operatively coupled in series with the first filter medium. The second filter medium is configured to facilitate physically removing insoluble colloidal lead from the water.

In a further aspect, a method is provided for removing soluble and insoluble lead from water supplied by a water source. The method includes operatively coupling a filter assembly to the water source. The filter assembly includes a housing in fluid communication with the water source and configured to receive unfiltered water, and a filter contained within the housing. The filter includes a first filter medium and a second filter medium in series with the first filter medium. Soluble lead is adsorbed as water is filtered through the first filter medium. Insoluble colloidal lead is physically removed as water is filtered through the second filter medium.

### BRIEF DESCRIPTION OF THE DRAWINGS

FIG. 1 is a sectional view of a dual stage filter having a first filtration medium and a second filtration medium positioned as an internal sleeve within an inner core defined by the first filtration medium.

FIG. 2 is a sectional view of a dual stage filter having a first filtration medium and a second filtration medium positioned as a core screen within an inner core defined by the first filtration medium.

FIG. 3 is a sectional view of a dual stage filter having a first filtration medium and a second filtration medium positioned as a cap screen at an exit opening defined by the filter assembly.

FIG. 4 is an exploded sectional view of a water distribution system including an exemplary dual stage filter assembly having a dual stage filter positioned within a housing.

### DETAILED DESCRIPTION OF THE INVENTION

The present invention provides a system and method for removing lead and other contaminants from water supplied by a water source to provide filtered drinking water suitable for consumption. By directing the source water through a dual stage filter assembly, at a point of entry (POE) or at a point of use (POU), soluble lead and insoluble colloidal or particulate lead, as well as other undesirable contaminants, are removed from the source water to provide filtered water suitable for consumption.

The present invention is described below in reference to its application in connection with and operation of a residential water filtration system. However, it should be apparent to those skilled in the art and guided by the teachings herein provided that the invention is likewise applicable to any water filtration system including, without limitation, industrial water filtration systems.

As used herein, references to “point of entry” are to be understood to refer to a location at which a supply of water from a water source, such as a municipal water distribution system or a well, for example, enters a building through a suitable inlet pipe. Further, as used herein, references to “point of use” are to be understood to refer to a location within or outside the building, such as at a sink or a water dispenser, where a user has access to water through suitable piping and/or connections.

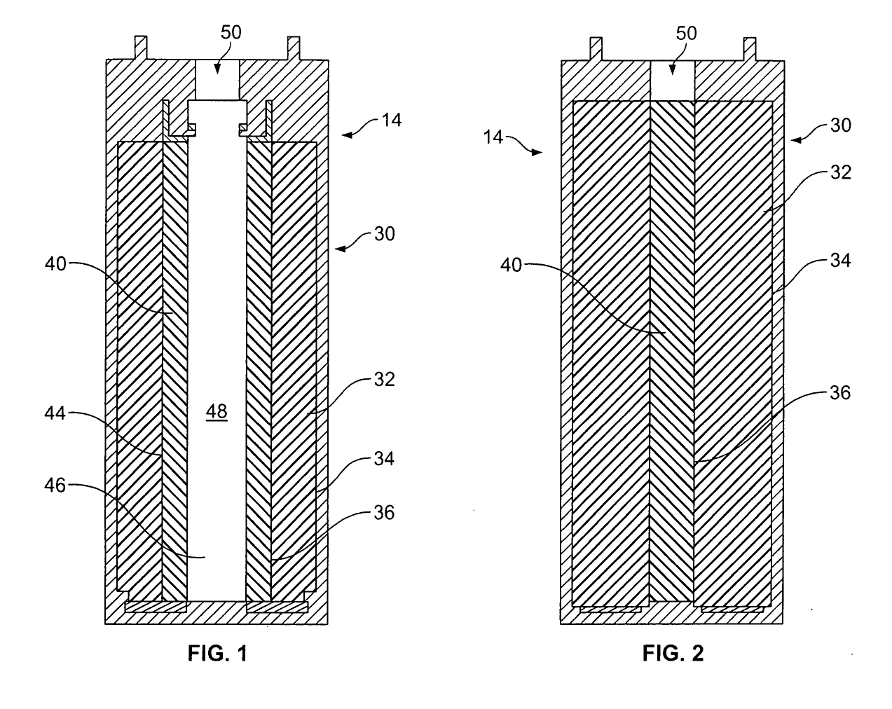

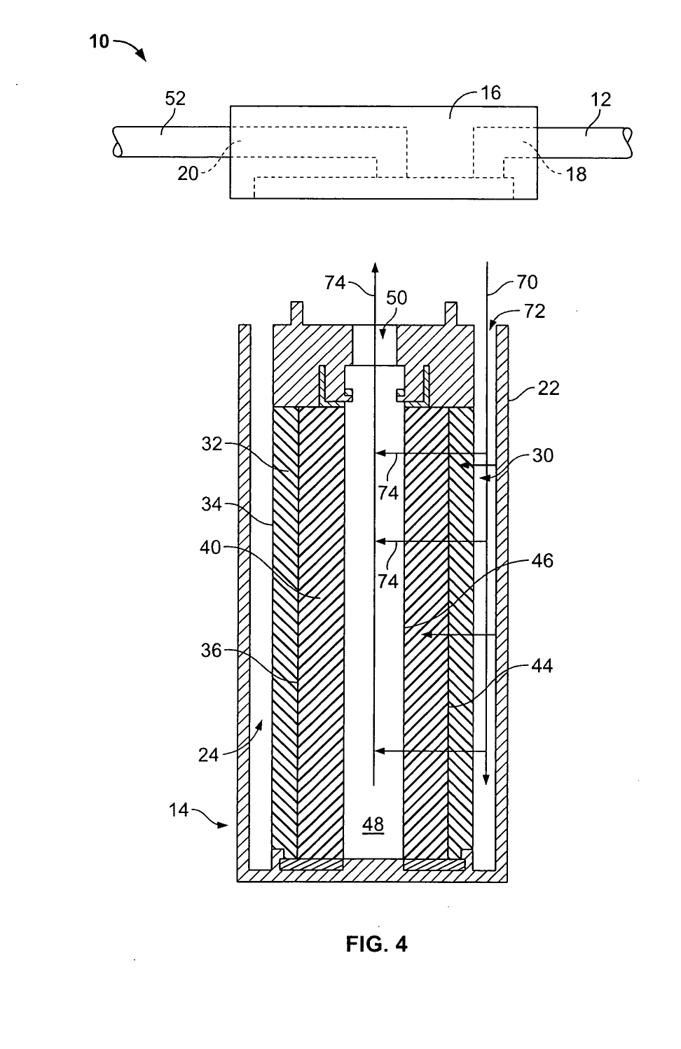

Referring to FIGS. 1-4, in one embodiment a water filtration system 10 for removing lead from water supplied by a water source (not shown) includes an inlet pipe 12, as shown in FIG. 4, and/or any suitable piping or connection in fluid communication with the water source, such as a municipal water distribution system. A filter assembly 14 is operatively coupled to inlet pipe 12 such that inlet pipe 12 provides fluid communication between the water source and filter assembly 14. In one embodiment, filter assembly 14 is coupled to a filter assembly cap 16, as schematically shown in FIG. 4. Filter assembly cap 16 includes an inlet 18 and an outlet 20 and is configured to direct water to flow through inlet pipe 12 and into filter assembly 14. After the water is filtered through filter assembly 14, the filtered water is directed through outlet 20 in filter cap assembly 16 for distribution.

Filter assembly 14 is configured to filter source water to remove lead, as well as other contaminants, therefrom and provide filtered water suitable for user consumption. Referring to FIG. 4, in one embodiment, filter assembly 14 includes a housing 22 that defines a chamber 24. Housing 22 is coupled to or integrated with filter assembly cap 16. In a particular embodiment, housing 22 is threadedly coupled to filter assembly cap 16. Chamber 24 has suitable dimensions to define a volume configured to receive and contain a dual stage filter 30.

Dual stage filter 30 includes a primary or first filter medium or screen 32. First filter medium 32 is configured to adsorb soluble lead to facilitate removing soluble lead from the source water. Additionally or alternatively, first filter medium 32 is configured to facilitate physically removing insoluble colloidal lead from the source water. In one embodiment, first filter medium 32 includes a weak cation exchange resin and/or a ceramic cation adsorption medium, such as an ATS ceramic cation adsorption media manufactured by BASF/Engelhard, configured to adsorb soluble lead. In this embodiment, the weak cation exchange resin and/or the ceramic cation adsorbent is contained within a support matrix including a suitable polypropylene material or other similar material. In alternative embodiments, first filter medium 32 is made of a suitable filter material including a medium to facilitate adsorbing soluble lead and/or physically removing insoluble colloidal lead from the source water. In particular embodiments, as shown in FIGS. 1 and 4, first filter medium 32 is fabricated of a suitable support material formed in a cylindrical configuration to define a cylindrical side wall 34. Cylindrical side wall 34 further defines a first or inner core 36.

Dual stage filter 30 also includes a secondary or second filter medium or screen 40 operatively coupled in series with first filter medium 32. Second filter medium 40 is configured to facilitate physically removing insoluble colloidal lead from the source water by size exclusion filtration. Size exclusion filtration is a process by which particles having a particle size greater than a pore size of the filter medium are filtered and removed from the source water flowing through the filter medium. Insoluble colloidal lead may exist in the source water as particles ranging in size between micron and submicron-sized particles and having a diameter of at least as small as about 0.45 microns (μm). In various embodiments, first filter medium 32 and/or second filter medium 40 are configured to remove the insoluble colloidal lead particles from the source water. In one embodiment, second filter medium 40 includes at least one microfiltration (MF) membrane or at least one ultrafiltration (UF) membrane. In alternative embodiments, second filter medium 40 includes a woven synthetic polymeric material and/or a carbon material having pore sizes less than that of insoluble colloidal lead.

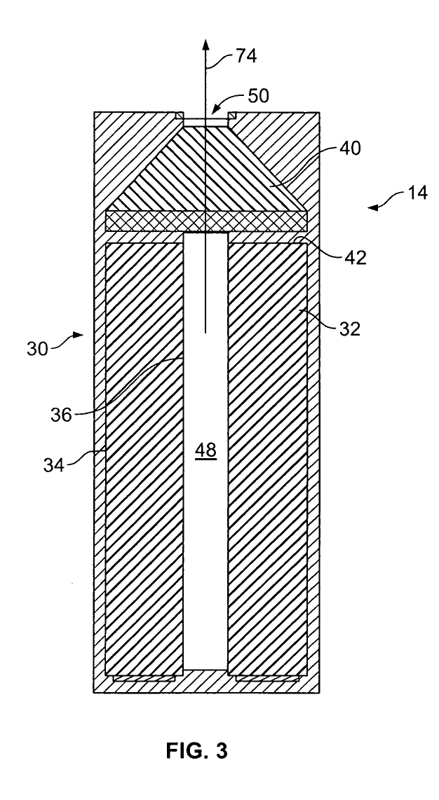

As shown in FIGS. 1-4, second filter medium 40 is positioned downstream from first filter medium 32 such that source water filtered through first filter medium 32 exits first filter medium 32 and is directed through second filter medium 40. Second filter medium 40 is positioned with respect to first filter medium 32 to facilitate removing colloidal lead not removed by first filter medium 32 prior to water exiting filter 30. In one embodiment, first filter medium 32 and second filter medium 40 are configured to facilitate physically removing from the source water insoluble colloidal lead having a particle size with a diameter less than about 1.5 microns, and in many cases between about 0.45 microns and about 1.5 microns. In a particular embodiment, first filter medium 32 is configured to physically remove insoluble colloidal lead having a relatively larger particle size and second filter medium 40 is configured to facilitate physically removing insoluble colloidal lead from the source water having a relatively smaller particle size. In this embodiment, dual stage filter 30 provides a size gradient filtration whereby each filter medium is configured to filter undesirable contaminants having different particle sizes from the source water. In a particular embodiment, second filter medium 40 is positioned with respect to an end surface 42 of first filter medium 32, as shown in FIG. 3.

Referring further to FIG. 1, in one embodiment second filter medium 40 is positioned within first core 36 defined by first filter medium 32. In this embodiment, second filter medium 40 is fabricated of a suitable support material formed in a cylindrical configuration to define a cylindrical side wall 44. Cylindrical side wall 44 further defines a second or inner core 46 that at least partially defines an axial water conduit 48 that provides an axial flow path through dual stage filter 30. An outlet opening 50 defined by water conduit 48 is in fluid communication with outlet 20 defined in filter assembly cap 16. The source water is directed through dual stage filter 30 and the resulting filtered water exits dual stage filter 30 into water conduit 48. The filtered water is then directed to flow from water conduit outlet opening 50 through outlet 20 and into an outlet pipe 52 coupled to filter assembly cap 16. Outlet pipe 52 is configured to distribute filtered water throughout the building water piping system to suitable water dispensing fixtures, such as a sink faucet and/or a refrigerator water dispensing system, for example.

Water filtration system 10 is operable as a point of entry water filtration system wherein source water is filtered to remove lead and other undesirable contaminants before filtered water is distributed through the building water piping system to coupled point of use fixtures or connections, such as sink facets and/or drinking water dispensers. Alternatively, water filtration system 10 is operable as a point of use water filtration system wherein source water is distributed through the building water piping system to coupled point of use fixtures or connections. Filter assembly 14 is operatively coupled to the building water piping system at or near the point of use to filter the source water.

In an alternative embodiment, second filter medium 40 is positioned within first core 36 such that first filter medium 32 and second filter medium 40 of dual stage filter 30 expand to substantially fill a volume of filter 30, as shown in FIG. 2. In a further alternative embodiment, second filter medium 40 is positioned downstream from first filter medium 32 and with respect to end surface 42 of first filter medium 32, as shown in FIG. 3.

In an alternative embodiment, first filter medium 32 is preceded by a filter medium or material that converts insoluble lead to soluble lead. This filter configuration functions by first converting the insoluble lead in the influent water to soluble lead, which is subsequently removed by the adsorbent medium of first filter medium 32. In this embodiment, dual stage filter assembly 14 facilitates removing insoluble colloidal lead from the influent water, either mechanically or by converting the insoluble lead to soluble lead, which can be chemically adsorbed by a soluble lead adsorbent medium. In a further alternative embodiment, second filter medium 40 is positioned upstream from first filter medium 32. In this embodiment, second filter medium 40 is configured to convert insoluble colloidal lead into soluble lead. The source water including the converted soluble lead exits second filter medium 40 and is directed into first filter medium 32, which is configured to adsorb soluble lead. As the source water is filtered through first filter medium 32, soluble lead is removed from the source water to provide filtered water suitable for user consumption.

Referring further to FIG. 4, in one embodiment a method for removing lead from water supplied by a water source is provided. Water filtration system 10 is operatively coupled to the water source such that an influent flow of source water 70 is directed through water filtration system 10. Influent flow of source water 70 flows through inlet pipe 12 and inlet 18 defined in filter assembly cap 16 into filter assembly 14. More specifically, water flows through inlet 18 and into housing 22 such that the source water flows along an inner surface of housing 22. In one embodiment, a circumferential gap or space 72 is at least partially defined between the inner surface of housing 22 and first filter medium 32 to direct influent flow of source water 70 into filter 30. Influent flow of source water 70 is directed to flow radially inwardly through first filter medium 32 positioned within housing 22 towards axial water conduit 48. More specifically, as shown in FIG. 4, influent flow of water 70 is directed radially inwardly through cylindrical side wall 34 of first filter medium 32.

As influent flow of water 70 is filtered through first filter medium 32, soluble lead is removed from the source water and adsorbed into first filter medium 32. In a particular embodiment, at least a portion of insoluble colloidal lead within the source water is removed as the source water is filtered through first filter medium 32. In this embodiment, insoluble colloidal lead, typically having a particle size less about 1.5 microns, is removed from the source water as the source water is filtered through first filter medium 32. Remaining insoluble colloidal lead having a particle size between about 0.45 microns and about 1.5 microns is removed from the partially filtered source water downstream as the partially filtered source water is filtered through second filter medium 40, described below.

The flow of partially filtered source water is directed radially inwardly through second filter medium 40 positioned within first core 36. As the partially filtered source water is filtered through second filter medium 40, insoluble colloidal lead is removed from the partially filtered source water. Effluent flow of filtered water 74 enters axial water conduit 48 and exits housing 22 through outlet opening 50 as filtered water suitable for user consumption, as desired.

In an alternative embodiment, as shown in FIG. 3, the partially filtered source water exiting first filter medium 32 enters axial water conduit 48. As the partially filtered source water flows through axial water conduit 48 to exit filter assembly 14, the partially filtered source water is filtered through second filter medium 40. As the partially filtered source water is filtered through second filter medium 40, insoluble colloidal lead is removed from the partially filtered source water. Effluent flow of filtered water 74 then exits housing 22 as filtered water suitable for user consumption, as desired.

In a further alternative embodiment, second filter medium 40 is positioned upstream from first filter medium 32. Second filter medium 40 is configured to facilitate converting insoluble colloidal lead into soluble lead as the source water is filtered through second filter medium 40. The partially filtered source water is then filtered through first filter medium 32 to facilitate removing soluble lead from the source water as the source water is filtered through first filter medium 32.

The above-described systems and methods for removing lead and other contaminants from source water provide filtered water suitable for user consumption. More specifically, by directing the source water through a dual stage filter assembly, at a point of entry (POE) or at a point of use (POU), soluble lead and insoluble colloidal or particulate lead, as well as other undesirable contaminants, are removed from the source water. As a result, potable filtered water can be reliably and efficiently distributed throughout a building water supply system.

Exemplary embodiments of systems and methods for providing filtered water suitable for user consumption are described above in detail. The systems and methods are not limited to the specific embodiments described herein, but rather, components of the system and/or steps of the method may be utilized independently and separately from other components and/or steps described herein. Further, the described system components and/or method steps can also be defined in, or used in combination with, other systems and/or methods, and are not limited to practice with only the systems and methods as described herein.

While the invention has been described in terms of various specific embodiments, those skilled in the art will recognize that the invention can be practiced with modification within the spirit and scope of the claims.

What is claimed is:

1. A filter for removing soluble and insoluble lead from water supplied by a water source, said filter comprising:
a first filter medium configured to adsorb soluble lead to facilitate removing soluble lead from the water; and
a second filter medium operatively coupled in series with said first filter medium, said second filter medium configured to facilitate physically removing insoluble colloidal lead from the water.

2. A filter in accordance with claim 1 wherein said first filter medium is configured to facilitate physically removing insoluble colloidal lead from the water.

3. A filter in accordance with claim 1 wherein said second filter medium comprises at least one of a microfiltration (MF) membrane, an ultrafiltration (UF) membrane, a woven synthetic polymeric material and a carbon material with pore sizes less than about 1.5 microns.

4. A filter in accordance with claim 1 wherein said second filter medium is positioned upstream from said first filter medium.

5. A filter in accordance with claim 4 wherein said second filter medium is configured to convert insoluble colloidal lead into soluble lead.

6. A filter in accordance with claim 1 wherein said second filter medium is positioned downstream of said first filter medium, said first filter medium configured to facilitate physically removing insoluble colloidal lead from the water having a particle size less than about 1.5 microns.

7. A filter in accordance with claim 1 wherein said first filter medium comprises a cylindrical side wall defining a first core, said second filter medium positioned within said first core.

8. A filter in accordance with claim 7 wherein said second filter medium comprises a cylindrical side wall defining a second core.

9. A filter in accordance with claim 1 wherein said second filter medium is positioned downstream of said first filter medium, said second filter medium positioned with respect to an end surface of said first filter medium.

10. A filter assembly coupled to a water distribution system for removing soluble and insoluble lead from water supplied by the water distribution system, the water distribution system comprising a filter assembly cap in fluid communication with the water source and defining an inlet and an outlet, said filter assembly comprising:
a filter housing coupled to the filter assembly cap and in fluid communication with the water source, said filter housing configured to receive unfiltered water through the inlet; and
a filter positioned within said filter housing, said filter comprising a first filter medium configured to adsorb soluble lead to facilitate removing soluble lead from the water and a second filter medium operatively coupled in series with said first filter medium, said second filter medium configured to facilitate physically removing insoluble colloidal lead from the water.

11. A filter assembly in accordance with claim 10 wherein an axial water conduit is defined through said filter, said axial water conduit in fluid communication with the outlet and configured to distribute filtered water.

12. A filter assembly in accordance with claim 10 wherein said second filter medium is positioned upstream from said first filter medium, said second filter medium configured to convert insoluble colloidal lead into soluble lead.

13. A filter assembly in accordance with claim 10 wherein said first filter medium comprises a cylindrical side wall defining a first core, said second filter medium positioned within said first core.

14. A filter assembly in accordance with claim 10 wherein said second filter medium is positioned downstream of said first filter medium, said second filter medium positioned with respect to an end surface of said first filter medium.

15. A method for removing soluble and insoluble lead from water supplied by a water source, said method comprising:
operatively coupling a filter assembly to the water source, the filter assembly comprising a housing in fluid communication with the water source and configured to receive unfiltered water, and a filter contained within the housing, the filter comprising a first filter medium and a second filter medium in series with the first filter medium;
adsorbing soluble lead as water is filtered through the first filter medium; and
physically removing insoluble colloidal lead as water is filtered through the second filter medium.

16. A method in accordance with claim 15 further comprising physically removing insoluble colloidal lead as water is filtered through the first filter medium.

17. A method in accordance with claim 15 further comprising positioning the second filter medium one of upstream and downstream from the first filter medium.

18. A method in accordance with claim 17 wherein, with the second filter medium positioned upstream from the first filter medium, said method further comprising converting insoluble colloidal lead into soluble lead as water is filtered through the second filter medium.

19. A method in accordance with claim 15 further comprising:
directing an influent flow of water radially inwardly through a cylindrical side wall of the first filter medium, the first filter medium defining a first core;
directing a flow of partially filtered water radially inwardly through the second filter medium positioned within the first core; and
directing an effluent flow of filtered water exiting the second filter medium through an axial water conduit defined through the filter.

20. A method in accordance with claim 15 further comprising:
directing an influent flow of water through the first filter medium;
positioning the second filter medium downstream of the first filter medium with respect to an end surface of the first filter medium;
directing a flow of partially filtered water through the second filter medium; and
directing an effluent flow of filtered water exiting the second filter medium through an axial water conduit defined through the filter.
